(19) United States
(12) Patent Application Publication
(10) Pub. No.: US 2026/0053610 A1
(43) Pub. Date: Feb. 26, 2026

(54) MODULAR DENTAL PROCEDURE SUPPLY SYSTEM

(71) Applicant: Mark Berdahl, Harrisburg, SD (US)

(72) Inventor: Mark Berdahl, Harrisburg, SD (US)

(21) Appl. No.: 19/304,915

(22) Filed: Aug. 20, 2025

Related U.S. Application Data
(60) Provisional application No. 63/732,510, filed on Aug. 23, 2024.

(51) Int. Cl. A61C 19/02

(52) U.S. Cl. CPC A61C 19/02

(57) ABSTRACT

A modular dental procedure supply system for organizing and storing dental procedure supplies and tools into modules according to specific procedures to facilitate collection and preparation of supplies and tools needed for the specific procedures. The system includes a base container defining an interior space. Each of a plurality of modular inserts is positionable in the interior space. Each of a plurality of materials is stored within an associated one of the modular inserts corresponding to a specific procedure such that the materials are organized into procedure specific collections of the materials for each of the modular inserts. A selected group of the modular inserts is positionable together within the interior space of the base container to correspond to procedures anticipated for an individual appointment.

### (b) CROSS-REFERENCE TO RELATED APPLICATIONS

This application claims priority to U.S. Provisional application 63/732,510 filed Aug. 23, 2024.

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to dental procedure supply organization device and more particularly pertains to a new dental procedure supply organization system for organizing and storing dental procedure supplies and tools into modules according to specific procedures to facilitate collection and preparation of supplies and tools needed for the specific procedures.

### (2) Description of Related Art Including Information Disclosed Under 37 CFR 1.97 and 1.98

The prior art relates to dental procedure supply organization device. Known dental tool and supply storage provides for color coordination related to specific procedures or other indicators for designation of tools and supplies to relate to specific procedures. However, known devices lack pre-organization of a collection of tools related to a specific procedure into a module such that tools and supplies anticipated to be needed at a particular dental appointment can be quickly and efficiently assembled into an appointment specific collection of modules encompassing all anticipated tools and supplies needed for the specific appointment.

### (h) BRIEF SUMMARY OF THE INVENTION

An embodiment of the disclosure meets the needs presented above by generally comprising a base container defining an interior space. Each of a plurality of modular inserts is positionable in the interior space. Each of a plurality of materials is stored within an associated one of the modular inserts corresponding to a specific procedure such that the materials are organized into procedure specific collections of the materials for each of the modular inserts. A selected group of the modular inserts is positionable together within the interior space of the base container to correspond to procedures anticipated for an individual appointment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front view of a modular dental procedure supply system according to an embodiment of the disclosure.

FIG. 2 is a top front side perspective view of an embodiment of the disclosure.

FIG. 3 is an exploded top front side perspective view of an embodiment of the disclosure.

FIG. 4 is an exploded top front side perspective view of an embodiment of the disclosure.

FIG. 5 is an exploded top front side perspective view of an embodiment of the disclosure.

FIG. 6 is a top front side perspective view of an insert of an embodiment of the disclosure.

FIG. 7 is a top front side perspective view of an insert of an embodiment of the disclosure.

FIG. 8 is a top front side perspective view of an insert of an embodiment of the disclosure.

FIG. 9 is a top front side perspective view of an insert of an embodiment of the disclosure.

FIG. 10 is a top front side perspective view of an insert of an embodiment of the disclosure.

FIG. 11 is a side view of an embodiment of the disclosure.

FIG. 12 is a front view of a storage cabinet of an embodiment of the disclosure.

FIG. 13 is a top front side perspective view of a cabinet component of an embodiment of the disclosure.

FIG. 14 is a front view of a storage cabinet of an embodiment of the disclosure.

FIG. 15 is a rear view of a storage cabinet of an embodiment of the disclosure.

### (j) DETAILED DESCRIPTION OF THE INVENTION

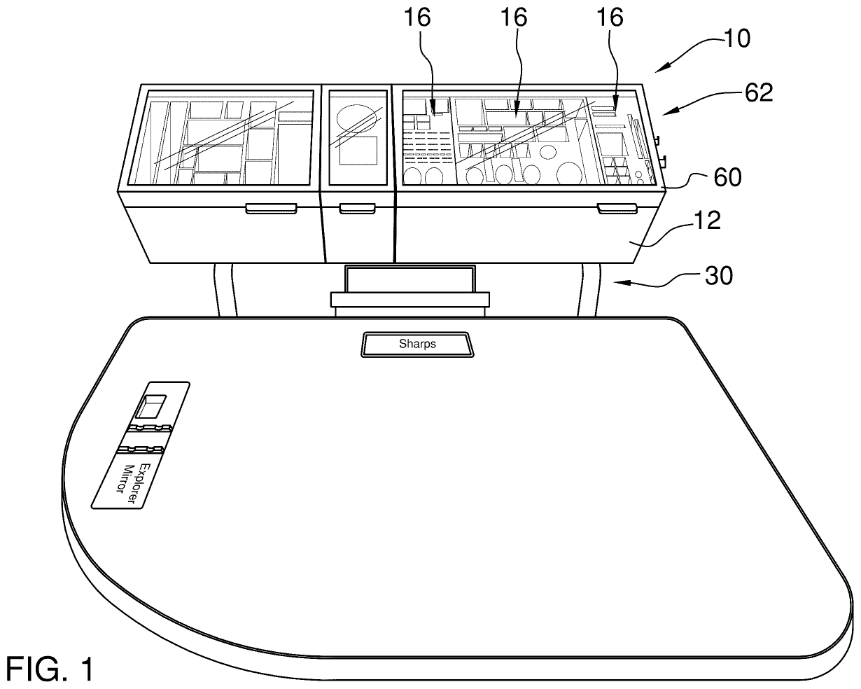

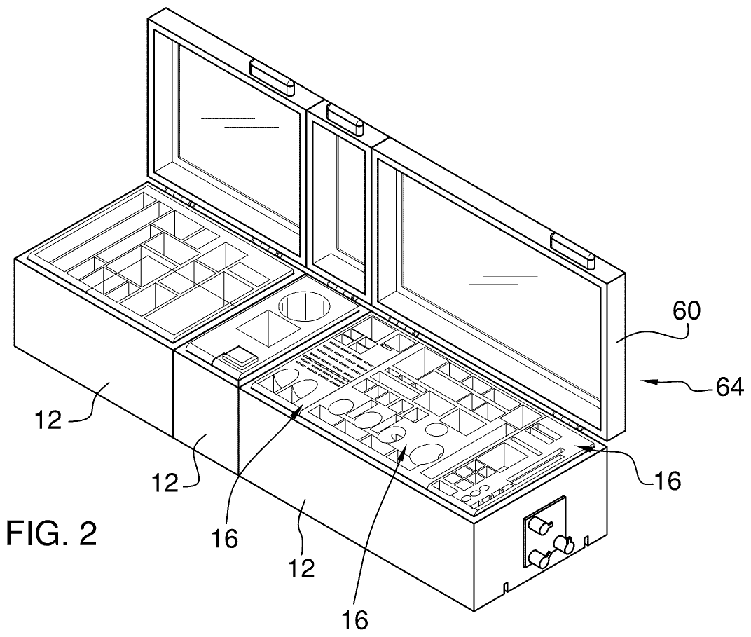

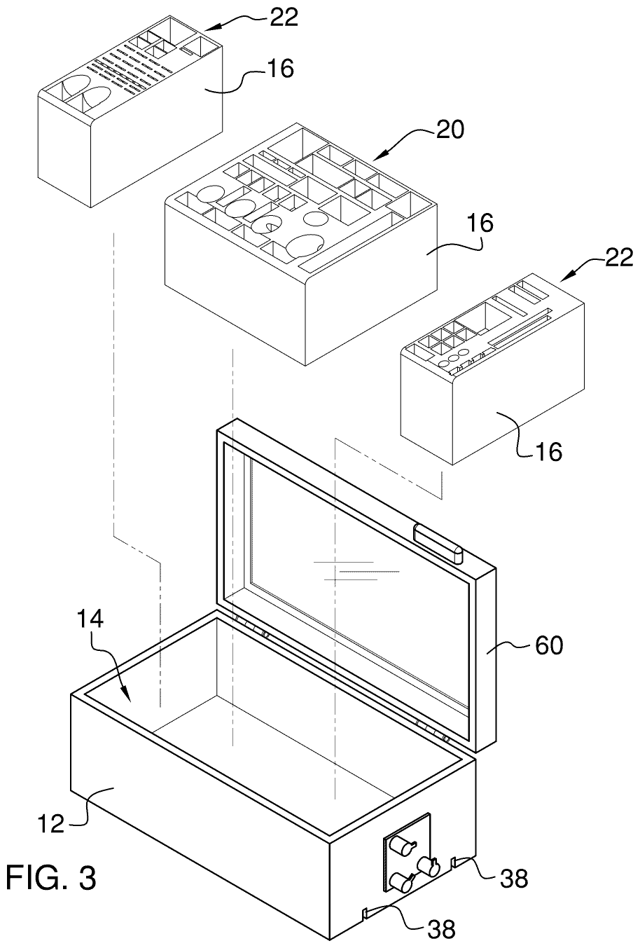

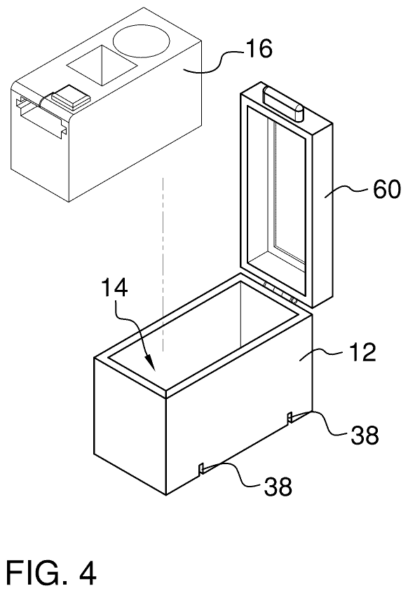

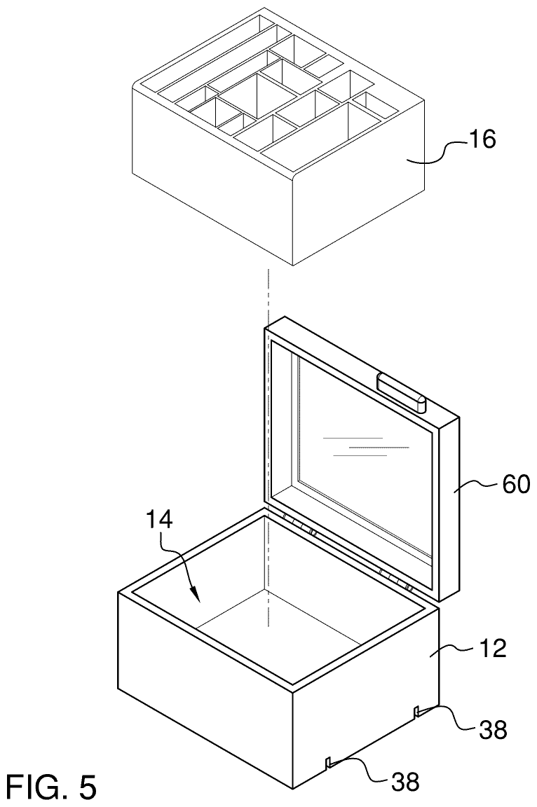

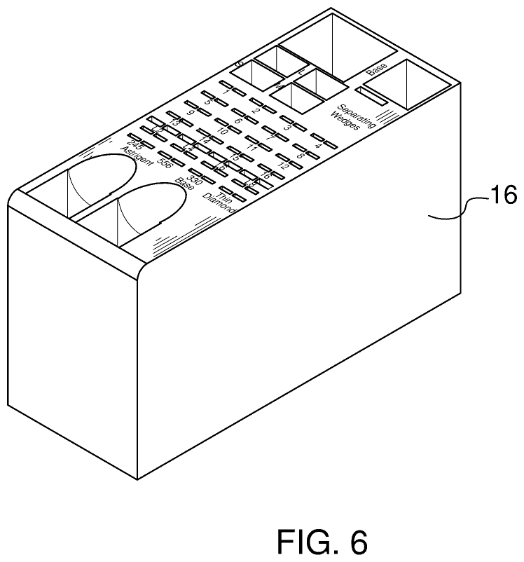

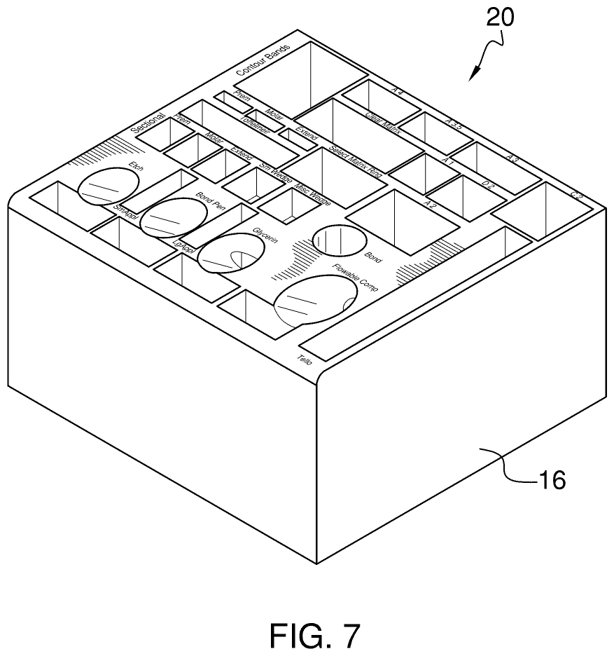

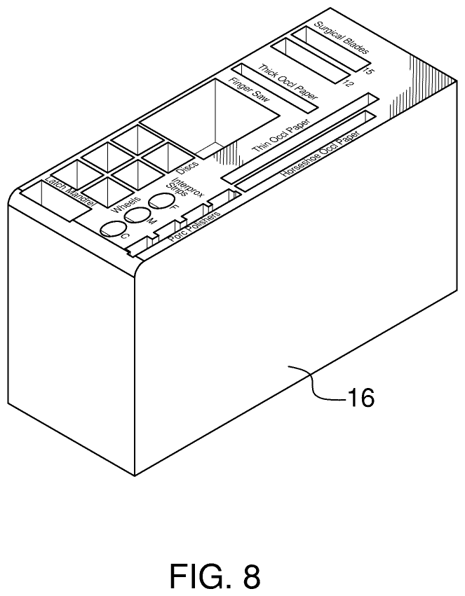

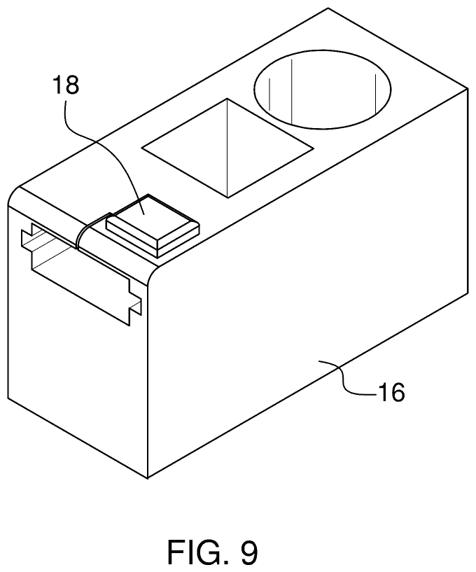

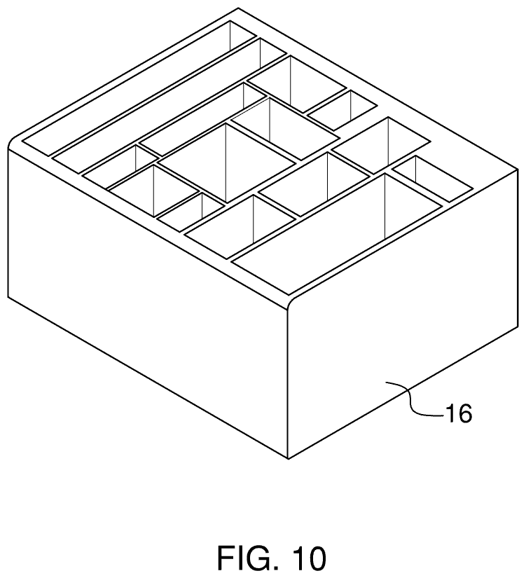

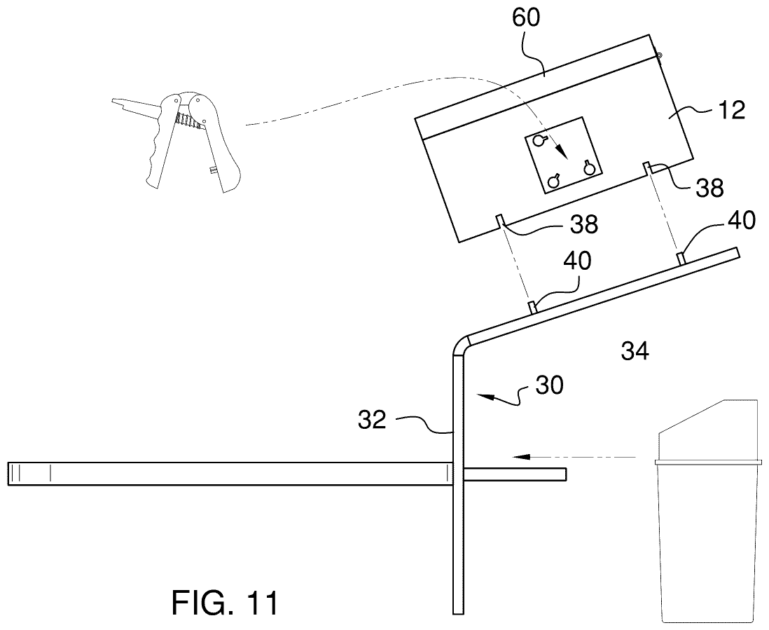

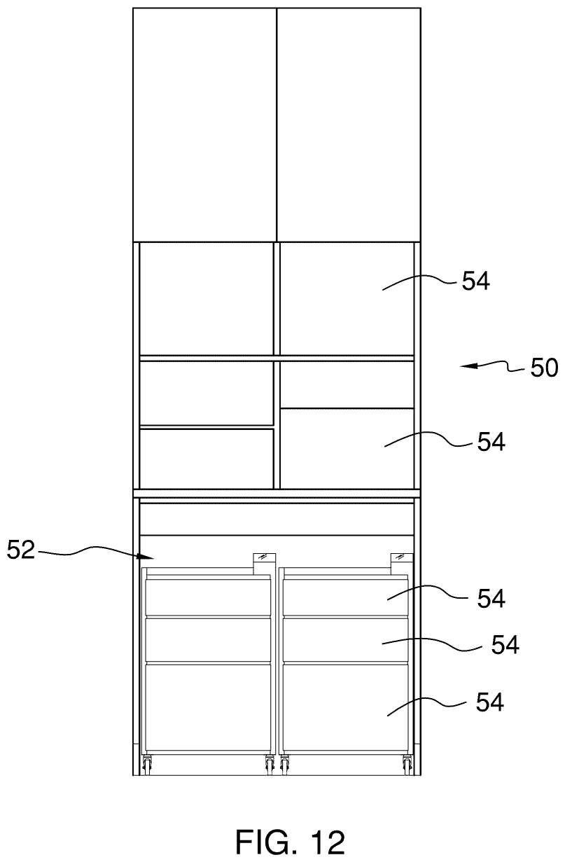

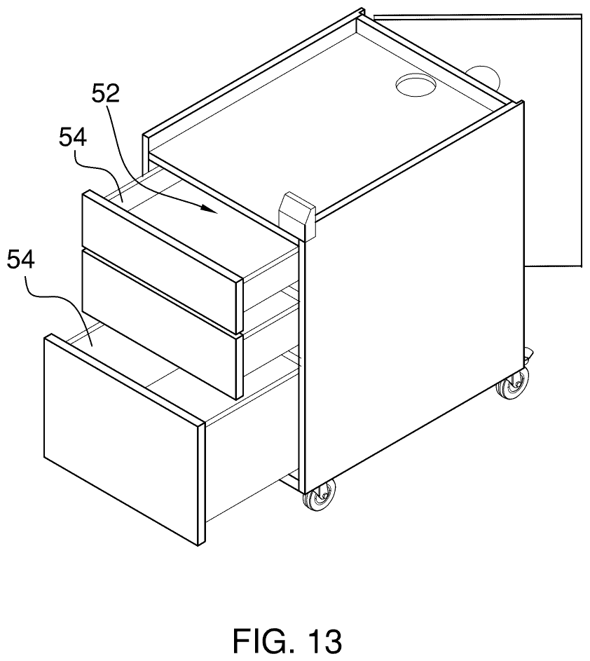

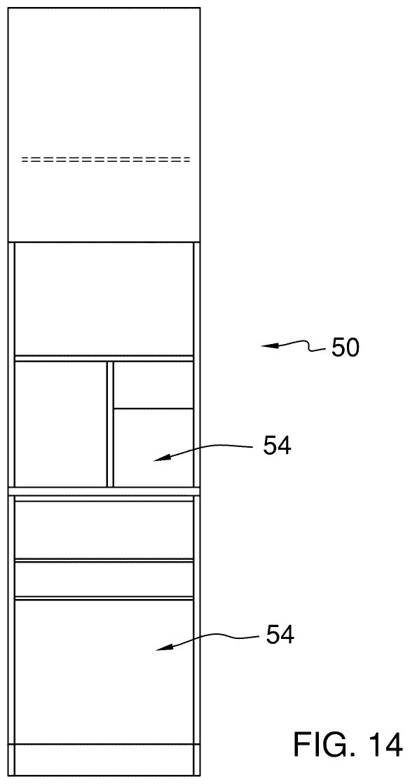

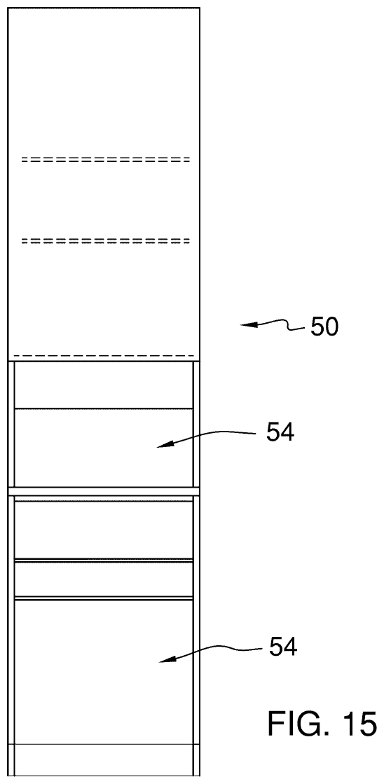

With reference now to the drawings, and in particular to FIGS. 1 through 15 thereof, a new dental procedure supply organization device embodying the principles and concepts of an embodiment of the disclosure and generally designated by the reference numeral 10 will be described.

As best illustrated in FIGS. 1 through 15, the modular dental procedure supply system 10 generally comprises a base container 12. The base container 12 defines an interior space 14. The system 10 further includes a plurality of modular inserts 16 and a plurality of materials 18. The materials 18 are tools, supplies, consumables, and the like required for procedures such as dental, medical, or the like required for a professional to perform general checkups as well as specific other procedures which may be scheduled for an appointment with the professional. While the context of the system 10 is applicable primarily to dental or medical appointments which regularly require specific materials 18, the system 10 is also applicable to other types of professionals in which organization and access to tools is desired, such as a vehicle mechanic. However, the system 10 is generally particularly applicable to those situations in which a professional is assisted by another person, the assistant routinely provides materials to the professional before and/or during the appointment, and in which reducing time to access the needed materials 18 can enhance efficiency and reduce total appointment duration to allow for more appointments to be scheduled within a given time period.

Each of the materials 18 is stored within an associated one of the modular inserts 16 corresponding to a specific procedure such that the materials 18 are organized into procedure specific collections of the materials 18 for each of the modular inserts 16.

Each modular insert 16 is selectable and insertable into the interior space 14 such that a group of selected the modular inserts 16 is positionable together within the interior space 14 of the base container 12. Thus, the group of selected modular inserts 16 is configured to be customizable to correspond to procedures anticipated for an individual appointment. The plurality of modular inserts 16 includes an essential modular insert 20 wherein the materials 18 associated with and stored in the essential modular insert 20 are those tools, supplies, and consumables to always be included in the group of selected modular inserts 16. That is, these are materials determined to be used or necessary for any particular appointment with the professional. These may be materials 18 having a high likelihood of being used in every appointment, or may be considered necessary to have immediately available for every appointment because the materials 18 might be needed in case of emergency during the appointment. Such materials 18 may also be provided for in a separate modular insert 16 dedicated to specifically being less likely to be needed during an appointment but generally being needed and accessible as soon as possible should a particular emergency arise during the appointment. The plurality of modular inserts 16 also includes a plurality of procedure specific modules 22 wherein the materials 18 associated with and stored in each procedure specific module 22 are tools, supplies and consumables corresponding to a specific procedure associated with the procedure specific module 22 for selective inclusion in the group of selected modular inserts 16. The collections of materials 18 may be varied or customized according to preferences or historical data of usage for particular procedures. The use of the modular inserts 16 allows for pre-organization and storage of the materials 18 within the modular inserts 16 which would otherwise normally be collected and assembled from separate storage. Color coding or other indicia may be used to facilitate differentiation and identification of each modular insert and materials to be included in the various modular inserts to facilitate inclusion of the correct materials 18 into each modular insert 16. Each modular insert 16 may also be customized as to having compartments for the materials 18 allowing for identification of empty spaces facilitating restocking of the modular inserts 16. The modular inserts may also be constructed to be sterilized, as may be needed, and to provide for a sterile environment for storage of the materials 18 until the modular insert 16 is selected for inclusion in the group of modular inserts 16 positioned in the base container 12 for a particular appointment.

The system 10 further includes provision of a rack 30 for positioning adjacent to a patient, or accessible to a professional using the materials 18, during the appointment. The rack 30 may have an upright section 32 vertically oriented and a support surface 34 which is angled to extend upwardly and away from a top 36 of the upright section 32. The base container 12 is positionable on the support surface 34 such that the base container 12 and the group of selected modular inserts 16 contained within the interior space 14 are accessible on the rack 30. A groove 38 is positioned on a bottom surface 40 of the base container 12. The groove 38 is oriented to extend laterally across the support surface 34. A tongue 40 is positioned on the support surface 34. The tongue 40 is positionable within the groove 38 when the base container 12 is placed on the support surface 34 wherein the tongue 40 and groove 38 inhibit the base container 12 from sliding off of the rack 30.

The system 10 may further incorporate a storage cabinet 50. The storage cabinet 50 defining an inner space 52. The inner space 52 of the storage cabinet 50 has compartments 54 such that the base container 12 and each of the modular inserts 16 is positionable within an associated one of the compartments 54 to facilitate identification and selection of the desired modular inserts 16 and corresponding materials 18 prior to occurrence of the appointment. The base container 12 and the plurality of modular inserts 16 is storable within the inner space 52 of the cabinet 50 with the plurality of materials 18 being stored in the plurality of modular inserts 16 allowing for efficient assembly of the group of selected modular inserts 16 for a particular appointment. A locking system 56 may be operationally coupled to the cabinet 50 such that access to the inner space 52 is selectively restricted.

A base lid 60 is pivotally coupled to the base container 12. The base lid 60 is pivotable between a covering position 62 and an access position 64. The base container 12 and the base lid 60 enclose the interior space 14 in the covering position 62. The base lid 60 extends away from the base container 12 exposing the interior space 14 in the access position 64 such that each of the materials 18 in the selected modular inserts 16 is accessible while the base lid 60 is in the access position 64. The base lid 60 is transparent such that the materials 18 in the selected modular inserts 16 positioned in the interior space 14 are visible through the base lid 60 when the base lid 60 is in the covering position 64.

It is also contemplated that each modular insert 16 may include a respective top, which would also be transparent, and that multiple base containers 12 may be selected and grouped to form a fully customized collection of desired materials 18.

In use, the modular inserts 16 are customized for grouping of the materials 18 desired to be in various modular inserts 16. The sizes of the modular inserts 16 may be varied and coordinated with various sizes of the base container 12 such that use of the interior space 14 of a specific base container 12 is fully used as additional confirmation that the necessary modular inserts 16 have been included in the base container 12 prior to the beginning of the appointment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular procedure based material storage and organization system comprising:
a base container, said base container defining an interior space;
a plurality of modular inserts;
a plurality of materials, each of said materials being stored within an associated one of said modular inserts corresponding to a specific procedure such that said materials are organized into procedure specific collections of said materials for each of said modular inserts; and
wherein each modular insert is insertable into said interior space such that group of selected said modular inserts are positionable together within said interior space of said base container whereby said group of selected modular inserts is configured to be customizable to correspond to procedures anticipated for an individual appointment.

2. The modular procedure based material storage and organization system of claim 1, further comprising said plurality of modular inserts including an essential modular insert wherein said materials associated with and stored in said essential modular insert are tools, supplies, and consumables to always be included in the group of selected modular inserts.

3. The modular procedure based material storage and organization system of claim 2, further comprising said plurality of modular inserts including a plurality of procedure specific modules wherein said materials associated with and stored in each procedure specific module are tools, supplies and consumables corresponding to a specific procedure associated with the procedure specific module for selective inclusion in the group of selected modular inserts.

4. The modular procedure based material storage and organization system of claim 1, further comprising:
a rack, said rack being configured for positioning adjacent to a patient during an appointment; and
said base container being positionable on said rack wherein said base container and said group of selected modular inserts contained within said interior space are accessible on said rack.

5. The modular procedure based material storage and organization system of claim 4, further comprising said rack having an upright section being vertically oriented and a support surface being angled to extend upwardly and away from a top of said upright section, said base container being positionable on said support surface.

6. The modular procedure based material storage and organization system of claim 5, further comprising:
a groove positioned on a bottom surface of said base container; and
a tongue positioned on said support surface, said tongue being positionable within said groove when said base container is placed on said support surface wherein said tongue and groove inhibit said base container from sliding off of said rack.

7. The modular procedure based material storage and organization system of claim 6, further comprising said groove being oriented to extend laterally across said support surface.

8. The modular procedure based material storage and organization system of claim 1, further comprising:
a storage cabinet, said storage cabinet defining an inner space; and
said base container and said plurality of modular inserts being storable within said inner space of said cabinet with said plurality of materials being stored in said plurality of modular inserts.

9. The modular procedure based material storage and organization system of claim 8, further comprising a locking system operationally coupled to said cabinet wherein access to said inner space is selectively restricted.

10. The modular procedure based material storage and organization system of claim 8, further comprising said inner space of said storage cabinet having compartments wherein said base container and each of said modular inserts is positionable within an associated one of said compartments.

11. The modular procedure based material storage and organization system of claim 1, further comprising a base lid pivotally coupled to said base container, said base lid being pivotable between a covering position and an access position, said base container and said base lid enclosing said interior space in said covering position, said base lid extending away from said base container exposing said interior space in said access position such that each of said materials in said selected modular inserts is accessible while said base lid is in said access position.

12. The modular procedure based material storage and organization system of claim 11, wherein said base lid is transparent such that said materials in said selected modular inserts positioned in said interior space are visible through said base lid when said base lid is in said covering position.

13. A modular procedure based material storage and organization system comprising:
a base container, said base container defining an interior space;
a plurality of modular inserts;
a plurality of materials, each of said materials being stored within an associated one of said modular inserts corresponding to a specific procedure such that said materials are organized into procedure specific collections of said materials for each of said modular inserts, wherein each modular insert is insertable into said interior space such that group of selected said modular inserts are positionable together within said interior space of said base container whereby said group of selected modular inserts is configured to be customizable to correspond to procedures anticipated for an individual appointment, said plurality of modular inserts including an essential modular insert wherein said materials associated with and stored in said essential modular insert are tools, supplies, and consumables to always be included in the group of selected modular inserts;
said plurality of modular inserts including a plurality of procedure specific modules wherein said materials associated with and stored in each procedure specific module are tools, supplies and consumables corresponding to a specific procedure associated with the procedure specific module for selective inclusion in the group of selected modular inserts;
a rack, said rack being configured for positioning adjacent to a patient during an appointment, said rack having an upright section being vertically oriented and a support surface being angled to extend upwardly and away from a top of said upright section, said base container being positionable on said support surface, said base container being positionable on said rack wherein said base container and said group of selected modular inserts contained within said interior space are accessible on said rack;
a groove positioned on a bottom surface of said base container, said groove being oriented to extend laterally across said support surface;
a tongue positioned on said support surface, said tongue being positionable within said groove when said base container is placed on said support surface wherein said tongue and groove inhibit said base container from sliding off of said rack;
a storage cabinet, said storage cabinet defining an inner space, said inner space of said storage cabinet having compartments wherein said base container and each of said modular inserts is positionable within an associated one of said compartments, said base container and said plurality of modular inserts being storable within said inner space of said cabinet with said plurality of materials being stored in said plurality of modular inserts;
a locking system operationally coupled to said cabinet wherein access to said inner space is selectively restricted; and
a base lid pivotally coupled to said base container, said base lid being pivotable between a covering position and an access position, said base container and said base lid enclosing said interior space in said covering position, said base lid extending away from said base container exposing said interior space in said access position such that each of said materials in said selected modular inserts is accessible while said base lid is in said access position, wherein said base lid is transparent such that said materials in said selected modular inserts positioned in said interior space are visible through said base lid when said base lid is in said covering position.
